(19) United States
(12) Patent Application Publication
(10) Pub. No.: US 2015/0334589 A1
(43) Pub. Date: Nov. 19, 2015

(54) MULTI-RADIO ACCESS TECHNOLOGY (RAT) MEASUREMENT SCHEDULING

(71) Applicant: QUALCOMM Incorporated, San Diego, CA (US)

(72) Inventors: Ming Yang, San Diego, CA (US); Tom Chin, San Diego, CA (US); Guangming Shi, San Diego, CA (US)

(73) Assignee: QUALCOMM Incorporated, San Diego, CA (US)

(21) Appl. No.: 14/278,948

(22) Filed: May 15, 2014

(51) Int. Cl. H04W 24/10; H04W 36/00; H04W 76/04

(52) U.S. Cl. CPC H04W 24/10; H04W 76/048; H04W 36/0088

(57) ABSTRACT

A method of wireless communication includes adaptively modifying a measurement schedule order for a current discontinuous reception cycle. The method also includes receiving system information for two or more cells. The measurement schedule order is based on a priority of a cell associated with a radio access technology, a frequency, or a combination thereof.

### BACKGROUND

1. Field

Aspects of the present disclosure relate generally to wireless communication systems, and more particularly, to adaptively modifying measurement schedule order for a current discontinuous reception cycle, in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes adaptively modifying a measurement schedule order for a current discontinuous reception cycle.

Another aspect of the present disclosure is directed to an apparatus including means for adaptively modifying a measurement schedule order for a current discontinuous reception cycle. The apparatus also includes means for receiving system information for two or more cells.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of adaptively modifying a measurement schedule order for a current discontinuous reception cycle.

Another aspect of the present disclosure is directed to an apparatus for wireless communication having a memory and at least one processor coupled to the memory. The processor(s) is configured to adaptively modifying a measurement schedule order for a current discontinuous reception cycle.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates an example for receiving system information blocks according to aspects of the present disclosure.

FIG. 6 is a block diagram illustrating a method for adaptively modifying a measurement schedule order according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

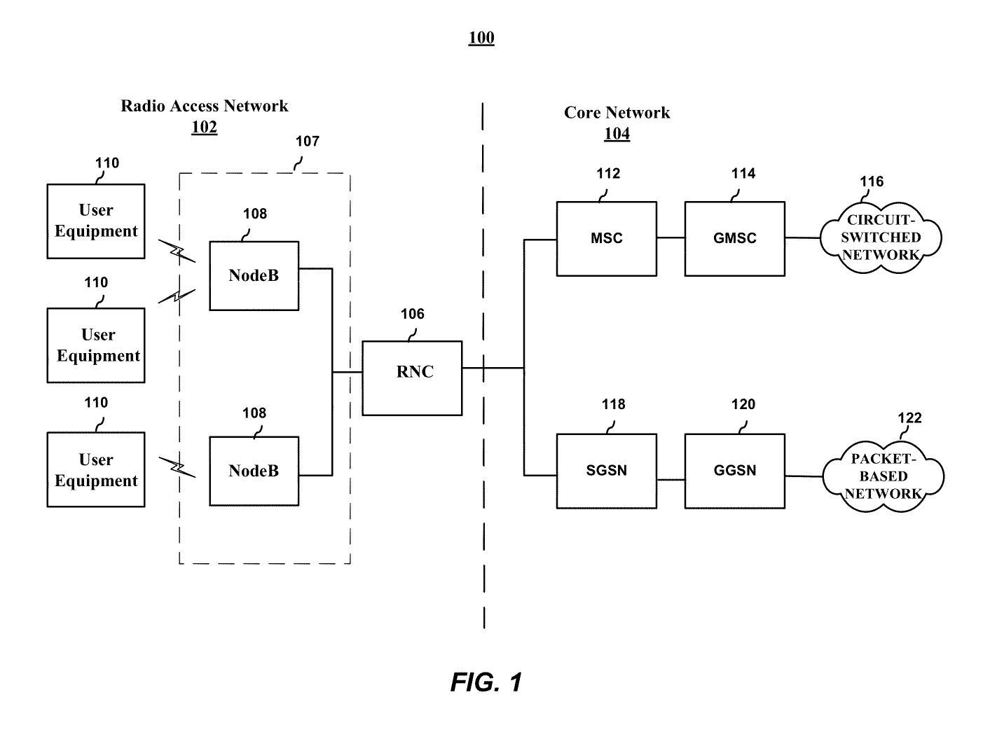

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

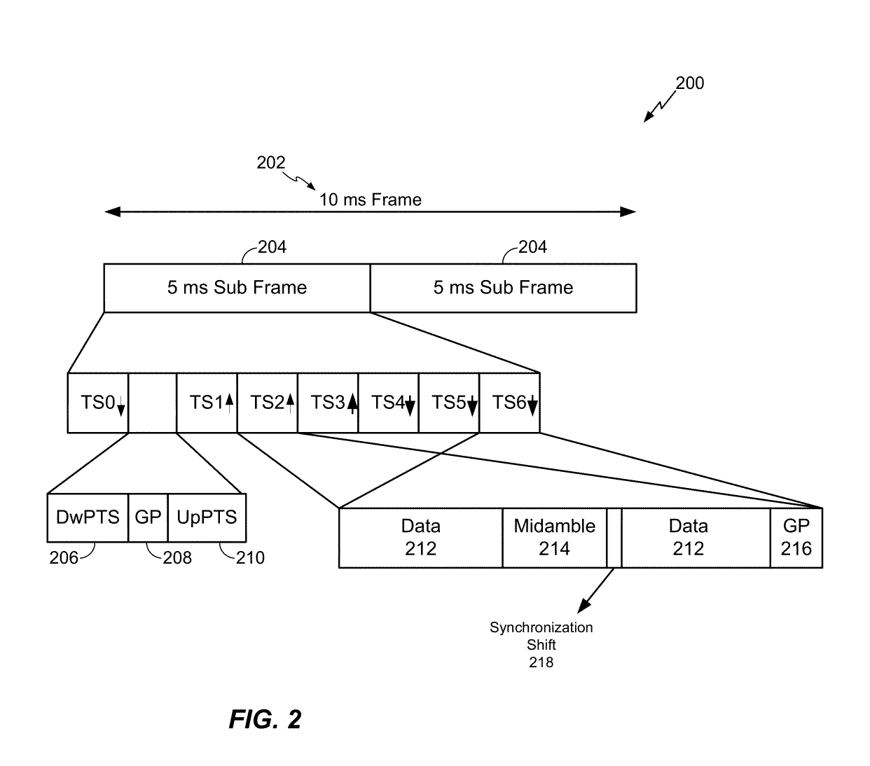

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

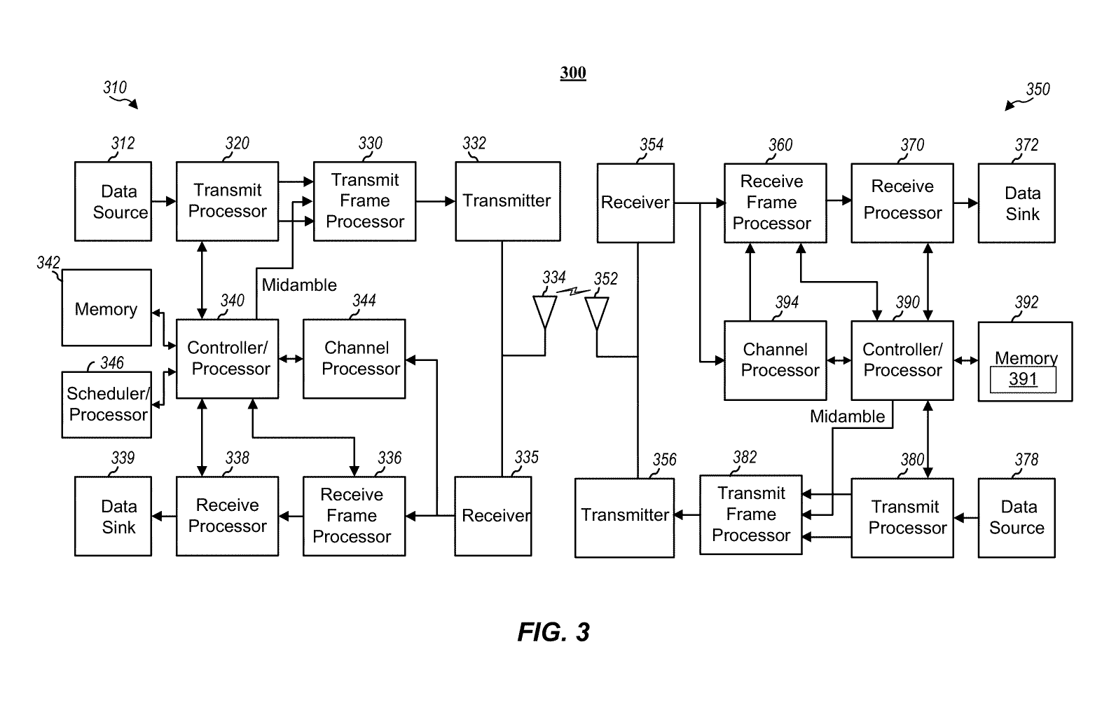

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store scheduling module 391 which, when executed by the controller/processor 390, configures the UE 350 for adaptively modifying a measurement schedule order for a current discontinuous reception (DRX) cycle. A scheduler/processor 346 at the node B 310 may be used to allocate resources to the UEs and schedule downlink and/or uplink transmissions for the UEs.

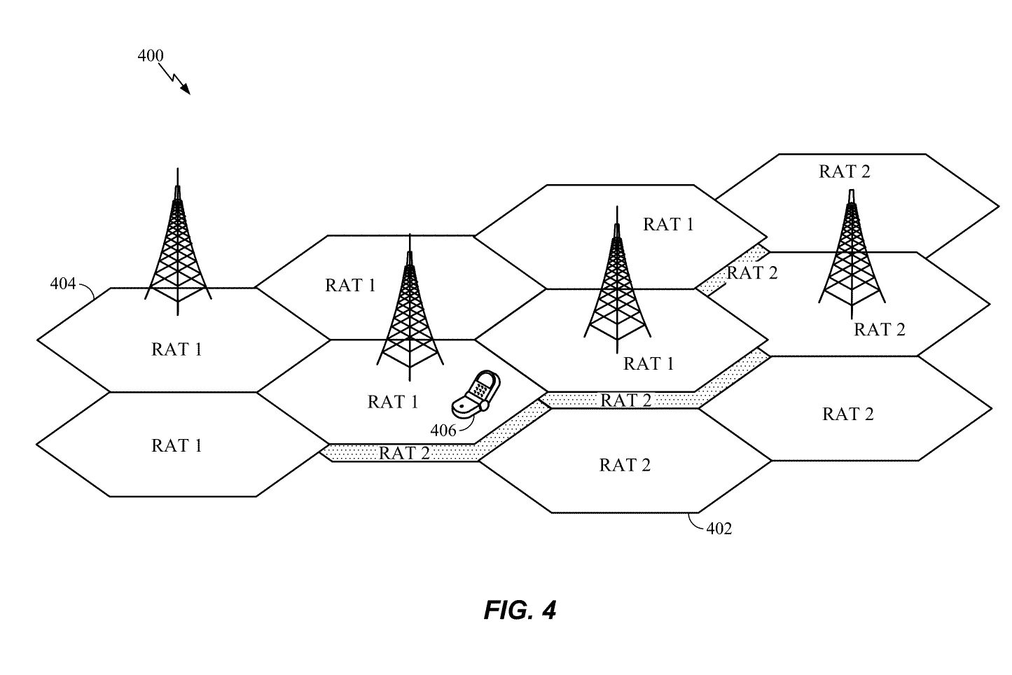

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

The BSIC of a cell in the second RAT is “verified” when the UE decodes the synchronization channel (SCH) of the broadcast control channel (BCCH) carrier, identifies the BSIC, at least one time, with an initial BSIC identification and reconfirms. The initial BSIC identification is performed within a predefined time period (for example, Tidentify_abort=5 seconds). The BSIC is re-confirmed at least once every Tre-confirm_abort seconds (e.g., Tre-confirm_abort=5 seconds). Otherwise, the BSIC of a cell in the second RAT is considered “non-verified.”

The UE maintains timing information of some neighbor cells, e.g., at least eight identified GSM cells in one configuration. The timing information may be useful for IRAT handover to one of the neighbor cells (e.g., target neighbor cell) and may be obtained from the BSIC. For example, initial timing information of the neighbor cells may be obtained from an initial BSIC identification. The timing information may be updated every time the BSIC is decoded.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., NodeB). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS <32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

### Multi-Rat Measurement Scheduling

When a UE is camped on a serving cell, during an idle period and when in a CELL_PCH state and/or a URA_PCH state, the UE may monitor a paging indicator channel (PICH) and/or a paging channel (PCH) of a serving cell, monitor system information, perform measurements for the cell, execute a cell reselection evaluation process, and/or select a non-serving cell when the non-serving cell satisfies certain conditions. The aforementioned cell refers to a serving cell and/or a non-serving cell.

In a conventional network deployment, the UE may be informed of various neighbor cells. Each cell may have a different priority level. The neighbor cells may be inter-RAT cells and/or intra-RAT cells. Furthermore, each neighbor cell may be a different RAT type. For example, priority levels 1, 2 and 3 may correspond to a first RAT such as long term evolution (LTE), a second RAT, such as TD-SCDMA, and a third RAT, such as GSM. Additionally, intra-frequency neighbor cells and inter-frequency neighbor cells may have priority levels the same as or different from the priority levels of the neighboring RATs, such as an LTE neighbor cell or a GSM neighbor cell.

In a conventional system, the UE schedules measurement of the serving cell, intra-frequency neighbor cells, inter-frequency neighbor cells, intra-RAT neighbor cells, and/or inter-RAT neighbor cells based on a fixed order. The order may be based on an order the UE receives in the form of neighbor cell system information, such as a system information block (SIB).

Measurements of the serving cell, intra-frequency neighbor cell, inter-frequency neighbor cell, intra-RAT neighbor cells, and/or inter-RAT neighbor cells are performed according to a measurement rate specified in a system specification. In some cases, to improve battery performance, after measuring the serving cell and decoding the paging indicator channel, the UE reduces the number of measurements it performs, such as, one of the neighbor cells every discontinuous reception cycle in a round robin procedure. In some cases, prioritizing an inter-frequency measurement and one inter-RAT measurement may prevent another inter-RAT measurement. For example, for a UE served by a TD-SCDMA cell, the UE may prioritize measuring a neighbor TD-SCDMA cell having the same frequency as the serving cell and a neighboring GSM cell. In this example, the prioritization may preclude the UE from measuring a neighboring LTE cell which may have an improved quality in comparison to the other cells (e.g., GSM and TD-SCDMA). That is, preventing measurement of a neighbor cell may result in a delay of a cell reselection to a neighbor cell with an improved signal strength and/or signal quality. That is, the UE may fail to select a desired neighbor cell and may miss a page due to delayed reselection process.

In one aspect of the present disclosure, the order of measurements is adaptively modified when multiple measurements are specified for a current discontinuous reception cycle. The multiple measurements may be specified by the network or by given standards. The modified order of measurement may be based on a priority of a cell associated with a specific RAT type and/or a specific frequency. In one aspect of the disclosure, the UE delays measurement or cell reselection for a low priority cell for a predefined period. Specifically, the UE may delay the measurement and/or reselection until receiving system information for a higher priority cell.

For example, the UE may monitor system information after an idle period and may receive the system information in a non-prioritized order, such as first receiving GSM system information, then LTE system information, followed by TD-SCDMA system information. In a conventional system, the UE would perform the cell measurements based on an order of the received system information. In one configuration, the UE may prioritize a measurement schedule for a current discontinuous reception period. For example, the UE may prioritize LTE cell measurements over measurements of other cells, such as GSM or TD-SCDMA. Thus, in this example, when the UE receives GSM system information, the UE delays the measurement and/or reselection for the GSM cell until after the UE has received the LTE system information and has performed measurements on the LTE cell.

Moreover, in one configuration, after receiving the system information for a low priority cell, the UE waits a specific time period for receiving the system information block for a higher priority cell. In this configuration, the UE performs measurements or reselection for the low priority cell if the UE does not receive the system information for a higher priority cell within the specific time period. For example, if the GSM cell has a low priority and the LTE cell has a higher priority, after the UE receives GSM system information, the UE delays the measurement and/or reselection for the GSM cell until after the UE has received the LTE system information. Alternatively, the UE performs measurements or reelection for the GSM cell if the UE does not receive the system information for the LTE cell within the specific time period.

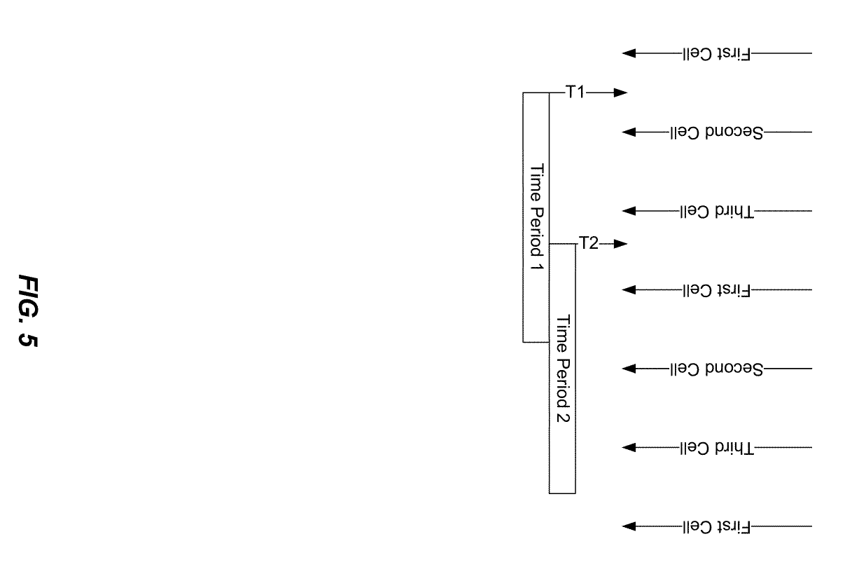

FIG. 5 illustrates a UE receiving system information of neighbor cells according to an aspect of the present disclosure. As shown in FIG. 5, a serving cell may periodically transmit system information of intra-RAT cells and inter-RAT cells (first cell, second cell, third cell). As an example, the first cell is a GSM cell, the second cell is a TD-SCDMA cell, and the third cell is an LTE cell. Moreover, in the present example, the serving cell is a TD-SCDMA cell. Aspects shown for FIG. 5 are not limited to intra-RAT cells and inter-RAT cells and are also contemplated for intra-frequency cells and/or inter-frequency cells.

Furthermore, as shown in FIG. 5, the UE wakes up at an arbitrary time period and receives system information subsequent to waking up. Still, because the wake up time for the UE is arbitrary, the UE is unaware as to which system information will be received upon waking up. For example, as shown in FIG. 5, if the UE wakes up at time T1, during a first time period, the UE will first receive the system information for the second cell, then the system information for the third cell, followed by the system information for the first cell. As another example, as shown in FIG. 5, if the UE wakes up at time T2, during a second time period, the UE will first receive the system information for the first cell, then the system information for the second cell, followed by the system information for the third cell.

As previously discussed, the UE may prioritize a specific cell, such as an LTE cell, over other cells, such as a GSM cell and/or a TD-SCDMA cell. The prioritization may be based on a RAT type of the cell and/or a frequency of the cell. As an example, in FIG. 5, the first cell is GSM, the second cell is TD-SCDMA, and the third cell is LTE. Moreover, in a conventional system, if the UE wakes up at time T1 (FIG. 5), the UE would perform measurements based on the order of receiving the system information, such as the second cell, then the third cell, followed by the first cell.

In contrast, based on an aspect of the present disclosure, if the UE has given priority to the third cell over both the second cell and the first cell, when the UE wakes up at time T1 (FIG. 5) and subsequently receives the system information of the second cell, the UE delays performing a measurement and/or a reselection for the second cell and waits for a time period, such as the first time period, to receive the system information of the third cell. That is, in one configuration, the UE delays performing measurements for the second cell until the UE has received the system information for the third cell. Accordingly, the UE does not perform cell reselection to the second cell when the measurements have yet to be performed. In another configuration, the UE measures the second cell, however, the UE delays performing a cell reselection to the second cell after performing the measurements if the measurements of the second cell are equal to or greater than a threshold.

In the present configuration, if the UE receives the system information of the third cell within a particular time period, the UE performs measurements and/or cell reselection for the third cell prior to performing measurements and/or reselection for the second cell. Alternatively, if the UE does not receive the system information block of the third cell within the time period, the UE performs measurements and/or reselection for the second cell.

Moreover, in the present configuration, the first cell has a higher priority in comparison to the second cell. Thus, in the present example, as shown in FIG. 5, after the UE wakes up at time T1 and receives the system information for the third cell, the UE waits for a time period to receive the system information of the first cell and perform measurements and/or reselection for the first cell before performing measurements and/or reelection for the second cell. If the UE does not receive the system information of the first cell within the time period, the UE performs measurements and/or reselection for the second cell.

In another configuration, the third cell has the highest priority, then the second cell, followed by the first cell. Thus, as shown in FIG. 5, in one example, when the UE wakes up at a time T2, within a specific time period, such a time period 2, the UE first receives the system information of the first cell and then the system information of the second cell. Still, because the third cell has the highest priority, the UE delays performing measurements and/or reselection for the first cell and the second cell until the UE receives the system information of the third cell and performs measurements and/or reselection for the third cell. After performing measurements and/or reselection for the third cell, the UE may perform measurements and/or reselection for the first cell and the second cell based on their prioritized order. Of course, if the UE does not receive the system information of the third cell within a time period, the UE may perform measurements and/or reselection for the first cell and the second cell based on their prioritized order.

In one configuration, if two or more cells have the same priority, the UE may perform measurements and/or reselection for a specific cell based on an order of receiving the system information block or other desired selection criteria. Alternatively, if two or more cells have the same priority, the UE may perform measurements and/or reselection for a specific cell until the UE has received the system information for all cells having the same priority.

As discussed above, the UE may wait to receive a system information for a specific cell and perform measurements and/or reselection for a second cell prior to performing measurements and/or reselection for a first cell even though the UE has already received the system information for the first cell. In one configuration, the UE is aware of the neighboring cells based on a network ID, such as a public land mobile network (PLMN) identification. Therefore, based on the network ID, the UE knows that it should receive the system information for a high priority cell within a time period after receiving the system information for a low priority cell.

Moreover, the UE may determine to wait to receive the system information for a higher priority cell based on a signal strength of a serving cell and/or a quality of the serving cell. For example, if the serving cell has a high quality, there is a decreased likelihood the UE will reselect another cell. Therefore, because of the decreased likelihood for performing a cell reselection, the UE may not wait to receive the system information for the higher priority cell.

In yet another configuration, the time period for waiting to receive system information of a higher priority cell is based on a stored measurement history, That is, the UE records the time spent to collect all system information and stores the recorded time as measurement history. In another configuration, the time period to wait for system information of a higher priority cell is based on a maximum length of time needed to receive system information for all neighbor cells, a time period for previously collecting system information, and/or a time period that the system information is stored in the UE's memory.

According to aspects of the present disclosure, measurements are performed sooner or more frequently for higher priority cells. The measurement schedule for the next discontinuous reception cycle may also be based on a measured signal strength and/or quality in a current discontinuous reception cycle. For example, the higher the signal strength and/or signal quality, then the higher the placement of the neighbor cell in the measurement order.

The measurement order may also be based on a device type, such as whether a device is circuit switched (CS) only or packet switched (PS) only. Moreover, the device type may also include whether the device is circuit switched preferred or packet switched preferred. For example, a UE may only support data connections, therefore, for a data UE, LTE measurements are prioritized higher than GSM measurements. As another example, a UE may only support voice calls, therefore, for a voice only UE, GSM measurements are prioritized higher than LTE measurements.

Aspects of the present disclosure mitigate delays in cell reselection and also mitigate problems that arise from missing a paging channel. Furthermore, aspects of the present disclosure mitigate the cell reselection to an undesirable RAT and/or frequency based on a fixed measurement order.

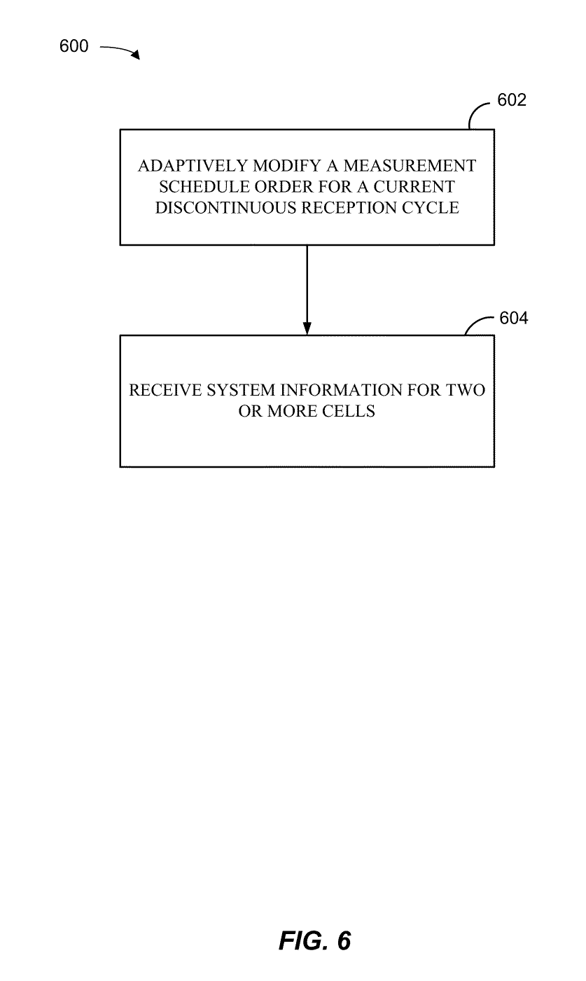

FIG. 6 shows a wireless communication method 600 according to one aspect of the disclosure. A UE adaptively modifies a measurement schedule order for a current discontinuous reception cycle, as shown in block 602. The UE also receives system information for two or more cells, as shown in block 604.

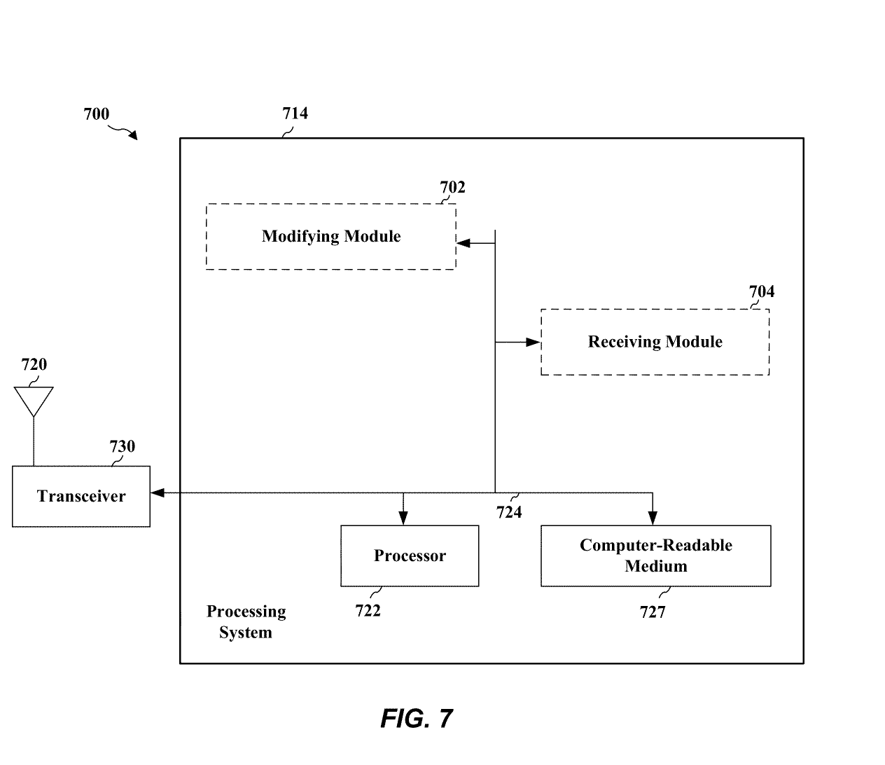

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and the non-transitory computer-readable medium 727. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 727. The processor 722 is responsible for general processing, including the execution of software stored on the computer-readable medium 727. The software, when executed by the processor 722, causes the processing system 714 to perform the various functions described for any particular apparatus. The computer-readable medium 727 may also be used for storing data that is manipulated by the processor 722 when executing software.

The processing system 714 includes a modifying module 702 for adaptively modifying a measurement schedule order for a current discontinuous reception cycle. The processing system 714 includes a receiving module 704 for receiving two or more system information blocks for different RATs. The modules may be software modules running in the processor 722, resident/stored in the computer readable medium 727, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for modifying. In one aspect, the modifying means may be the channel processor 394, the receive frame processor 360, the receive processor 370, the controller/processor 390, the memory 392, the scheduling module 391, the modifying module 702, and/or the processing system 714 configured to perform the modifying. The UE is also configured to include means for receiving. In one aspect, the receiving means may be the antennas 352, the receiver 354, the channel processor 394, the receive frame processor 360, the receive processor 370, the controller/processor 390, the memory 392, the scheduling module 391, the receiving module 704 and/or the processing system 714 configured to perform the receiving. In one configuration, the means functions correspond to the aforementioned structures. In another aspect, the aforementioned means may be a module or any apparatus configured to perform the functions recited by the aforementioned means.

Several aspects of a telecommunications system has been presented with reference to TD-SCDMA and LTE, GSM, W-CDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
adaptively modifying a measurement schedule order for a current discontinuous reception (DRX) cycle.

2. The method of claim 1, in which the measurement schedule order is based at least in part on a priority of a cell associated with a radio access technology (RAT), a frequency, or a combination thereof.

3. The method of claim 2, further comprising waiting to receive system information for a higher priority cell before measuring a lower priority RAT or lower priority frequencies.

4. The method of claim 2, further comprising waiting to receive system information for a higher priority cell before performing a cell reselection to a lower priority cell.

5. The method of claim 1, in which the measurement schedule order for a next DRX cycle is based at least in part on a measured signal quality in the current DRX cycle.

6. The method of claim 1, in which the measurement schedule order is based at least in part on whether a device is circuit switched (CS) or packet switched (PS).

7. The method of claim 3, further comprising determining whether to wait based at least on part on a signal strength of a serving cell, a signal quality of the serving cell, or a combination thereof.

8. The method of claim 3, further comprising determining whether to wait based at least on part on a public land mobile network (PLMN) identification stored in memory.

9. The method of claim 3, further comprising determining whether to wait based at least on part on a recorded measurement history.

10. The method of claim 3, further comprising determining a time period for waiting based at least in part on a maximum length of time needed to receive the system information for all neighbor cells, a time period for previously collecting the system information, a time period of the system information is stored in a memory.

11. An apparatus for wireless communication, comprising:
a memory unit; and
at least one processor coupled to the memory unit, the at least one processor being configured:
to adaptively modifying a measurement schedule order for a current discontinuous reception (DRX) cycle.

12. The apparatus of claim 11, in which the measurement schedule order is based at least in part on a priority of a cell associated with a radio access technology (RAT), a frequency, or a combination thereof.

13. The apparatus of claim 12, in which the at least one processor is further configured to wait to receive system information for a higher priority cell before measuring a lower priority RAT or lower priority frequencies.

14. The apparatus of claim 12, in which the at least one processor is further configured to wait to receive system information for a higher priority cell before performing a cell reselection to a lower priority cell.

15. The apparatus of claim 11, in which the measurement schedule order for a next DRX cycle is based at least in part on a measured signal quality in the current DRX cycle.

16. The apparatus of claim 11, in which the measurement schedule order is based at least in part on whether a device is circuit switched (CS) or packet switched (PS).

17. The apparatus of claim 13, in which the at least one processor is further configured to determine whether to wait based at least on part on a signal strength of a serving cell, a signal quality of the serving cell, or a combination thereof.

18. The apparatus of claim 13, in which the at least one processor is further configured to determine whether to wait based at least on part on a public land mobile network (PLMN) identification stored in memory.

19. The apparatus of claim 13, in which the at least one processor is further configured to determine whether to wait based at least on part on a recorded measurement history.

20. The apparatus of claim 13, in which the at least one processor is further configured to determine a time period for waiting based at least in part on a maximum length of time needed to receive the system information for all neighbor cells, a time period for previously collecting the system information, a time period of the system information is stored in a memory.

21. An apparatus, comprising:
means for adaptively modifying a measurement schedule order for a current discontinuous reception (DRX) cycle; and
means for receiving system information for two or more cells.

22. The apparatus of claim 21, in which the measurement schedule order is based at least in part on a priority of a cell associated with a radio access technology (RAT), a frequency, or a combination thereof.

23. The apparatus of claim 22, further comprising means for waiting to receive system information for a higher priority cell before measuring a lower priority RAT or lower priority frequencies.

24. The apparatus of claim 22, further comprising means for waiting to receive system information for a higher priority cell before performing a cell reselection to a lower priority cell.

25. The apparatus of claim 1, in which the measurement schedule order for a next DRX cycle is based at least in part on a measured signal quality in the current DRX cycle.

26. An apparatus for wireless communication, comprising:
a memory unit; and
at least one processor coupled to the memory unit, the at least one processor being configured:
to adaptively modifying a measurement schedule order for a current discontinuous reception (DRX) cycle.

27. The apparatus of claim 26, in which the measurement schedule order is based at least in part on a priority of a cell associated with a radio access technology (RAT), a frequency, or a combination thereof.

28. The apparatus of claim 27, in which the program code further comprises program code to wait to receive system information for a higher priority cell before measuring a lower priority RAT or lower priority frequencies.

29. The apparatus of claim 27, in which the program code further comprises program code to wait to receive system information for a higher priority cell before performing a cell reselection to a lower priority cell.

30. The apparatus of claim 26, in which the measurement schedule order for a next DRX cycle is based at least in part on a measured signal quality in the current DRX cycle.
